(19) United States
(12) Patent Application Publication
(10) Pub. No.: US 2016/0131095 A1
(43) Pub. Date: May 12, 2016

(54) VALVE, IN PARTICULAR AN ENGINE CONTROL VALVE, EQUIPPED WITH A METERING GATE AND A DIVERTER GATE

(71) Applicant: VALEO SYSTEMES DE CONTROLE MOTEUR, Cergy Saint Christophe (FR)

(72) Inventors: Nicolas Martin, Maisonslafitte (FR); Grégory Hodebourg, Sartrouville (FR)

(73) Assignee: Valeo Systemes de Controle Moteur, Cergy Saint Christophe (FR)

(21) Appl. No.: 14/783,594

(22) PCT Filed: Apr. 14, 2014
(86) PCT No.: PCT/FR2014/050902

§ 371 Date: Jan. 19, 2016

(30) Foreign Application Priority Data
Apr. 12, 2013 (FR) 1353357

(51) Int. Cl. F02M 35/10; F16K 31/53; F16K 11/052

(52) U.S. Cl. CPC F02M 35/10255; F16K 11/052; F16K 31/535

(57) ABSTRACT

The invention relates to a valve comprising: at least three channels (2, 9, 11) opening into a common space; a metering gate (12) pivotable in a first channel (2); a diverter gate (10) pivotable between a position for shutting off a second (9) or third (11) channel; and an actuation device (15) for actuating the gates (10, 12), said actuation device (15) comprising an actuation wheel (16) for actuating at least one of the gates and having at least a first configuration in which the metering gate (12) does not shut off the first channel (2) and the diverter gate (10) does not shut off the second (9) or third (11) channel. The actuation device (15) is configured such that, while in the first configuration, the rotation of the actuation wheel (16) causes: the diverter gate (10) to pivot substantially as the diverter gate (12) pivots slightly; and, subsequently, the metering gate (12) to pivot.

The invention relates to a valve, in particular an engine control valve, provided with a metering gate and a diverter gate. The metering gate is generally able to pivot in a duct to vary the gas passage section, and the diverter gate is designed to pivot between a first position shutting off a first channel and a second position shutting off a second channel. Such a valve can, for example, be placed in the portion of an air intake circuit of a heat engine downstream from a compressor, the metering gate regulating the gas flow rate in said engine and the diverter gate being able to shut off either an access channel to a supercharged air cooler, or a bypass channel bypassing the cooler. The valve can comprise a metering gate and a diverter gate controlled by an improved actuating mechanism of said gates.

There is a need for a valve using a metering gate and a diverter gate that can be moved by a shared actuating mechanism, the valve being able to be used on a portion of an air intake circuit of an engine, in particular a diesel engine, downstream from a compressor.

The invention relates to a valve, in particular an engine control valve, comprising:
at least three channels opening into a common inner space,
a metering gate pivotable in a first channel to vary the passage section of the fluid in the latter,
a diverter gate pivotable between a position for shutting off a second channel and a position for shutting off a third channel,
a shared actuating device of the gates,
   the actuating device including at least one actuating wheel rotatable to pivot at least one of the diverter gate and the metering gate,
   the actuating device having at least one first configuration in which the metering gate is in a position in which it does not shut off the first channel and in which the diverter gate is in an intermediate position in which it is not in the position shutting off the second channel or in the position shutting off the third channel, and
   the actuating device being configured so that the rotation of the actuating wheel while the actuating device is in the first configuration leads to:
according to a first phase, substantial pivoting of the diverter gate while the metering gate is only subject to slight pivoting, and
according to a second phase after the first phase, pivoting of the metering gate to alter the passage section of the fluid in the first channel without the position of the diverter gate being modified.
   Within the meaning of the present application, a gate shuts off a channel when it prevents fluid from traveling in that channel.

In the first configuration, the metering gate can be in the completely open position of the first channel.

In other words, in a first phase, when the diverter gate pivots from the first configuration to a shutoff position, the metering gate is only subject to slight pivoting, from a completely open position of the first channel. In this way, the metering gate remains in a quasi-open position of the first channel, when the diverter gate pivots to reach a shutoff position. This configuration is particularly interesting when the valve is for example placed in the portion of an air intake circuit of a heat engine downstream from a compressor, the diverter gate, by moving, not potentially having to deprive the heat engine of intake gases.

In a second phase, the actuating wheel then continues its rotation in the same direction, the continuation of the rotation making it possible to regulate the fluid in the first channel without preventing maintenance of the diverter gate in the shutoff position.

The actuating wheel can pivot, during the second phase, in the same rotation direction as during the first phase that immediately precedes it.

The first configuration can be an idle position of the metering gate and the diverter gate.

The metering gate can have no sealing segment.

The metering gate can have a rotation axis and the gate can extend in a plane including said rotation axis. In other words, the metering gate can pivot around its rotation axis.

The actuating device can be configured so that the rotation of the actuating wheel while the actuating device is in the first configuration leads to the pivoting of the metering gate in one rotation direction, depending on the rotation direction of the actuating wheel.

In other words, depending on the rotation direction of the actuating wheel, from the first configuration, the metering gate pivots clockwise or in the trigonometric direction, for opening thereof.

Such a valve only uses a single actuating wheel to pivot both gates.

Preferably, the actuating device can be configured so that the rotation of the actuating wheel while the actuating device is in the first configuration leads to:
in a first rotation direction, the pivoting of the diverter gate to the shutoff position of the second channel, and
in a second rotation direction, the pivoting of the diverter gate to the shutoff position of the third channel.

Advantageously, the actuating device can be able to keep the diverter gate in one or the other of the shutoff positions of the second or third channel, while the actuating wheel continues a unidirectional rotational movement from the first configuration.

In other words, once the diverter gate reaches a position shutting off the second or third channel, the actuating wheel can continue the rotational movement in the same direction that it had to bring the diverter gate into said shutoff position. The continuation of this rotational movement does not prevent maintenance of the diverter gate in a shutoff position.

For example, starting from the first configuration and by rotating the actuating wheel in a first rotation direction, the actuating device can
in a first phase, make it possible to pivot the diverter gate substantially to a position shutting off the second channel and pivot the metering gate slightly in a predetermined rotation direction, and
in a second, subsequent phase, and for the same rotation direction of the actuating wheel as in the preceding first phase, keep the diverter gate in the reached shutoff position, and pivot the metering gate in the predetermined rotation direction to adjust the passage section of the fluid in the first channel.

In the same example, starting from the first configuration and by rotating the actuating wheel in a second rotation direction opposite the first direction, the actuating device can,
in a first phase, make it possible to simultaneously pivot the diverter gate to a shutoff position of the third channel and pivot the metering gate slightly in a rotation direction opposite said predetermined rotation direction, and
in a second, subsequent phase, and for the same rotation direction of the actuating wheel as in the preceding first phase, keep the diverter gate in the reached shutoff position, and pivot the metering gate in the same rotation direction that it had in the first phase, i.e., in the rotation direction opposite said predetermined rotation direction, to adjust the passage section of the fluid in the first channel.

Advantageously, the actuating device can comprise an actuating system of the diverter gate, said actuating system comprising a guide part and an interface part, the actuating wheel being rigidly coupled to the guide part and the diverter gate being rigidly coupled to the interface part, the guide part cooperating with the interface part to pivot the diverter gate.

The actuating device can comprise a system for actuating the metering gate, said actuating system comprising a guide member and an interface part, the actuating wheel being connected to the guide member so as to pivot the latter during its rotation, and the interface part being rigidly coupled to the metering gate, and the guide member cooperating with said interface part to pivot the metering gate.

Preferably, the guide member of the actuating system of the metering gate and the guide part of the actuating system of the diverter gate can be separate and rigidly connected to one another.

Alternatively, the guide member of the actuating system of metering gate and the guide part of the actuating system of the diverter gate can be formed in a single and same piece.

Advantageously, the actuating wheel cooperates with the guide part of the actuating system of the diverter gate via a first zone of said wheel and the actuating wheel cooperates with the guide member of the actuating system of the metering gate via a second zone of said wheel, different from the first zone.

For example, the first zone and the second zone can have different radial positions and/or different angular positions, and/or in the case where the actuating wheel has two opposite parallel faces, be positioned on different faces of said wheel.

For example, the second zone can cooperate indirectly with the guide member of the actuating system of the metering gate, an intermediate part for example being inserted between the actuating wheel and said guide member. This intermediate part in particular axially separates the guide member from the actuating wheel.

Preferably, the guide member of the actuating system of the metering gate can comprise a pinion cooperating with the interface part of the actuating system of the metering gate.

The guide member of the actuating system of the metering gate can be another wheel coaxial with the actuating wheel.

The interface part can be a toothed sector.

The effect of such a pinion meshing on the interface part is to allow the pivoting of the metering gate in a rotation direction depending on the rotation direction of the actuating wheel, starting from its open position of the first channel.

The effect of such a pinion meshing on the interface part is to create a reduction ratio to have a precise metering while allowing the diverter gate to pivot more quickly.

According to a first example embodiment, the interface part of the actuating system of the diverter gate can be configured to define a guide path of the guide part with which it cooperates.

One such example embodiment is described in detail in French application no. 1,352,230, filed on Mar. 13, 2013 by the Applicant, the content of which is incorporated by reference into this application.

Advantageously, the guide path can be formed by a blind slot arranged in said interface part, said guide part resting in the blind slot when the diverter gate is in the intermediate position.

Advantageously, said guide part can exert, when it rests in the slot and under the effect of a rotation of the actuating wheel, thrust on said interface part to pivot the diverter gate.

Advantageously, the actuating system of the diverter gate can comprise a maintaining part for the interface part of said actuating system, said maintaining part being rigidly coupled with the actuating wheel.

Advantageously, said maintaining part and said interface part can comprise complementary surfaces, such that the cooperation between these complementary surfaces keeps said interface part in position during the movement of said guide part, while the diverter gate is in one or the other of the shutoff positions.

For example, said complementary surfaces can be arcs of circle with substantially the same radius.

The actuating wheel, the guide part of the actuating system of the diverter gate, the guide part of the actuating system of the metering gate and the maintaining part of the interface part of the actuating system can be separate and rigidly coupled to one another.

Alternatively, the actuating wheel, the guide part of the actuating system of the diverter gate, the guide member of the actuating system of the metering gate and the maintaining part of the interface part of the actuating system can be formed in a single and same piece.

According to another embodiment, the guide path can be formed by a guide housing arranged in the guide part of the actuating system of the diverter gate, said guide housing having two opposite lateral edges against which the guide part selectively comes into contact, when the diverter gate pivots to one or the other of the shutoff positions.

Such an example embodiment is described in detail in French application no. 1,352,229, filed on Mar. 13, 2013 by the Applicant, and the content of which is incorporated into this application by reference.

Preferably, the guide housing can comprise two segments having a shared end.

Advantageously, at each end opposite the shared end of the segment, the lateral edge of the segment closest to the other segment extends radially beyond the other lateral edge of said segment.

Advantageously, said guide part can further define a maintaining path of said interface part to maintain the diverter gate in one or the other of the shutoff positions.

Preferably, the maintaining path and the guide path can communicate by at least one shared lateral edge.

Advantageously, a spring can cooperate with the body of the valve and the interface part of the actuating system of the diverter gate, and be configured to selectively keep the diverter gate in the shutoff position.

Advantageously, the valve can be placed in a portion of an air intake circuit of a heat engine, for example a diesel engine, in particular of a vehicle, said portion being downstream from a compressor and said portion comprising a supercharged air cooler and a bypass channel bypassing said cooler, the metering gate regulating the gas flow in said engine and the diverter gate shutting off either an access channel to said cooler, or the bypass channel bypassing the cooler.

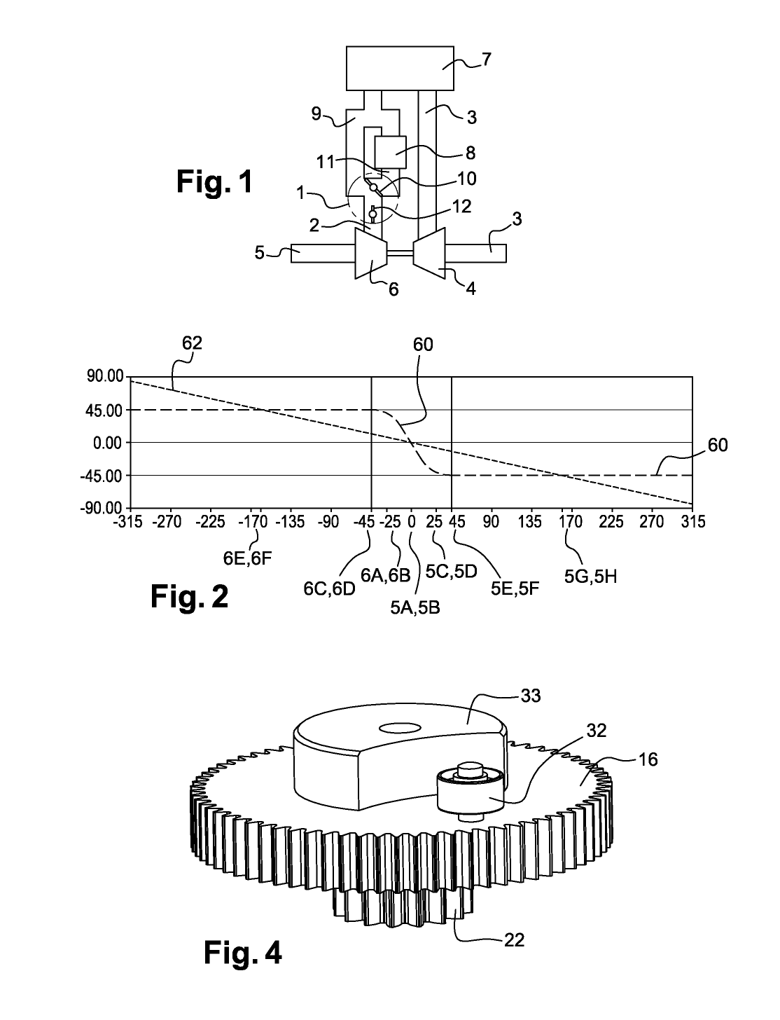

Below, a detailed description is provided of one preferred embodiment of a valve according to the invention, in reference to FIGS. 1 to 7C.

FIG. 1 is a diagrammatic view of a heat engine in which the valve can be used.

FIG. 2 is a diagram showing the angular position of the metering gate and the diverter gate as a function of the angular position of the actuating wheel.

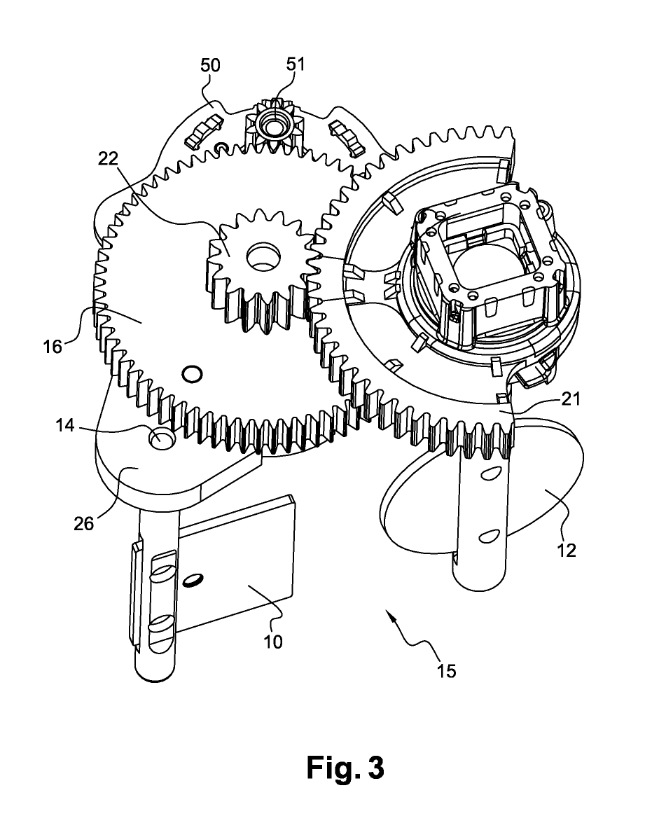

FIG. 3 is a perspective view of a valve according to the invention.

FIG. 4 is a perspective view of part of the actuating device of a valve according to the invention.

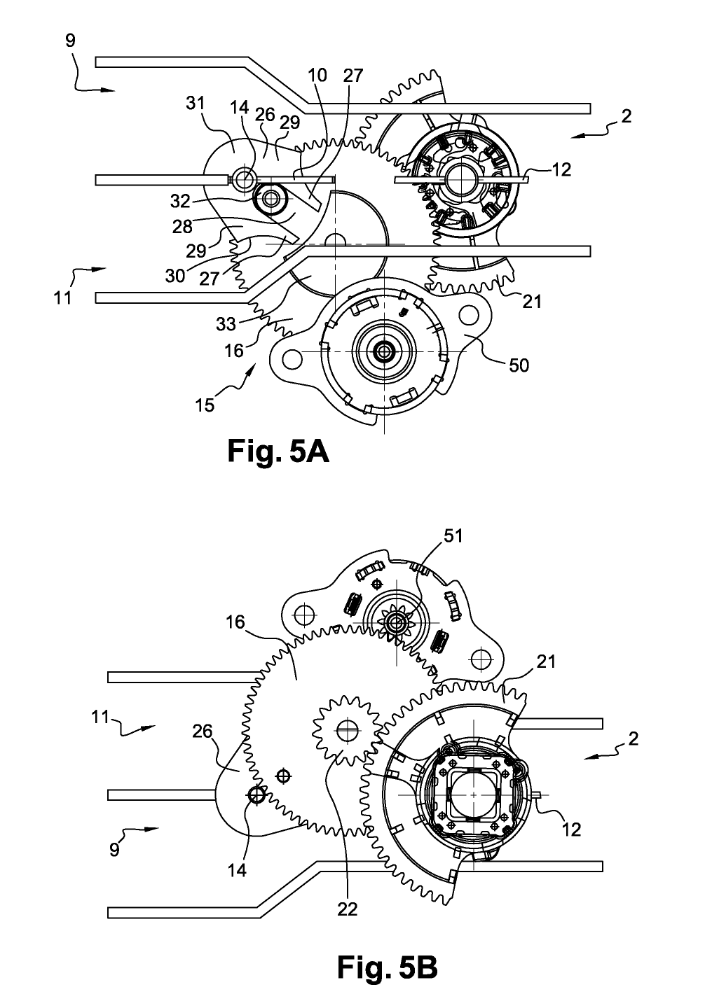

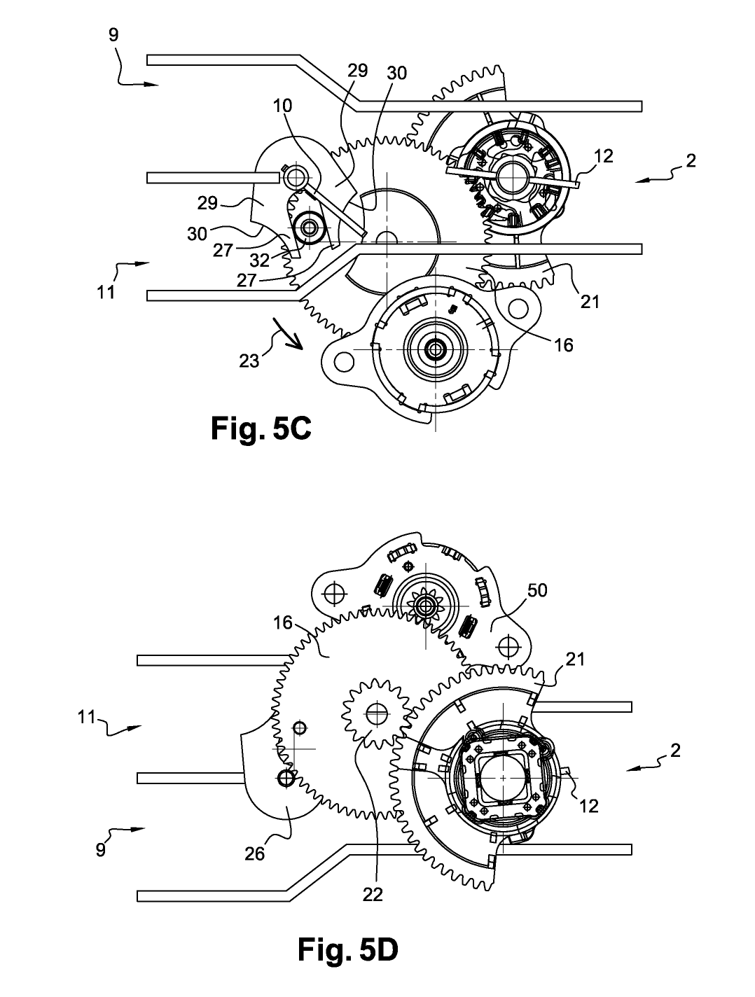

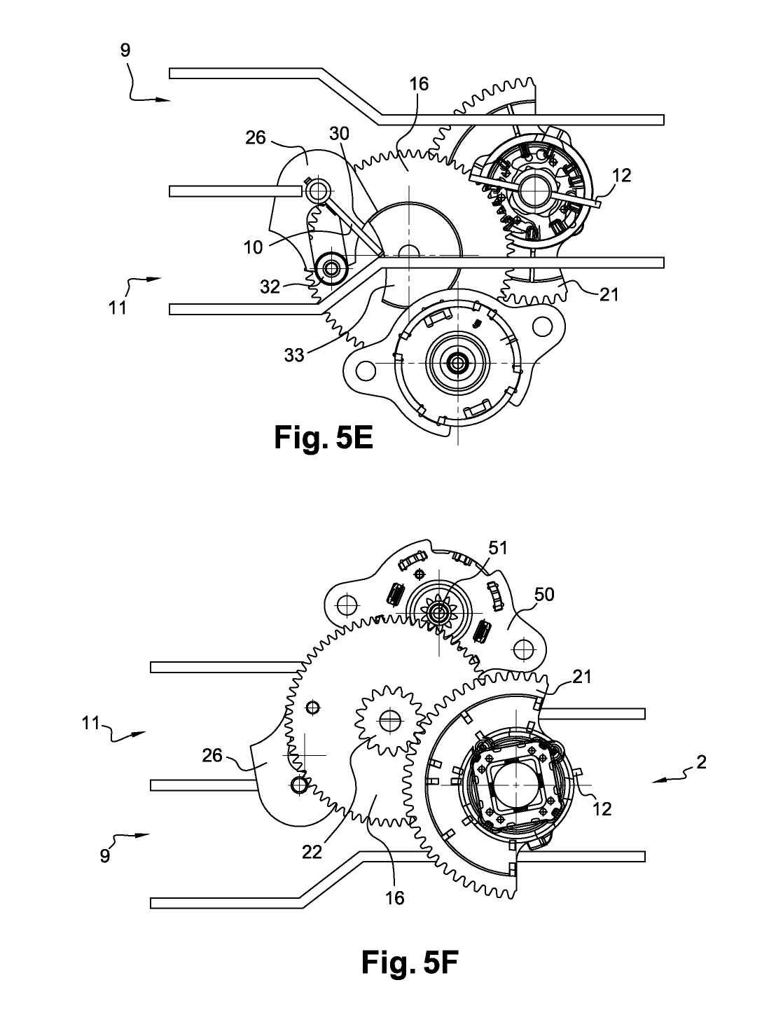

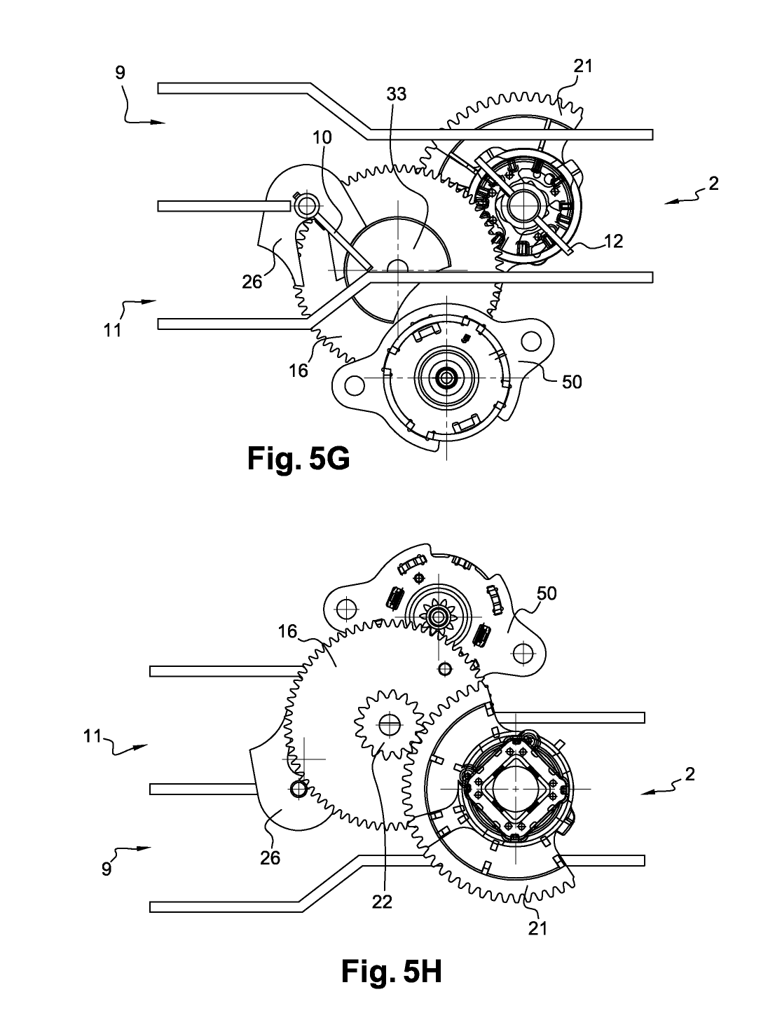

FIGS. 5A and 5B are bottom and top views, respectively, of the actuating device of the valve according to the invention, the actuating device being in a first configuration.

FIGS. 5C, 5E and 5G are bottom views of the actuating device of a valve according to the invention, with four different rotational stages in the same direction of the actuating wheel, starting from the first configuration.

FIGS. 5D, 5F and 5H are top views of the actuating device of the valve according to the invention, in the states as shown in FIGS. 5C, 5E and 5G, respectively.

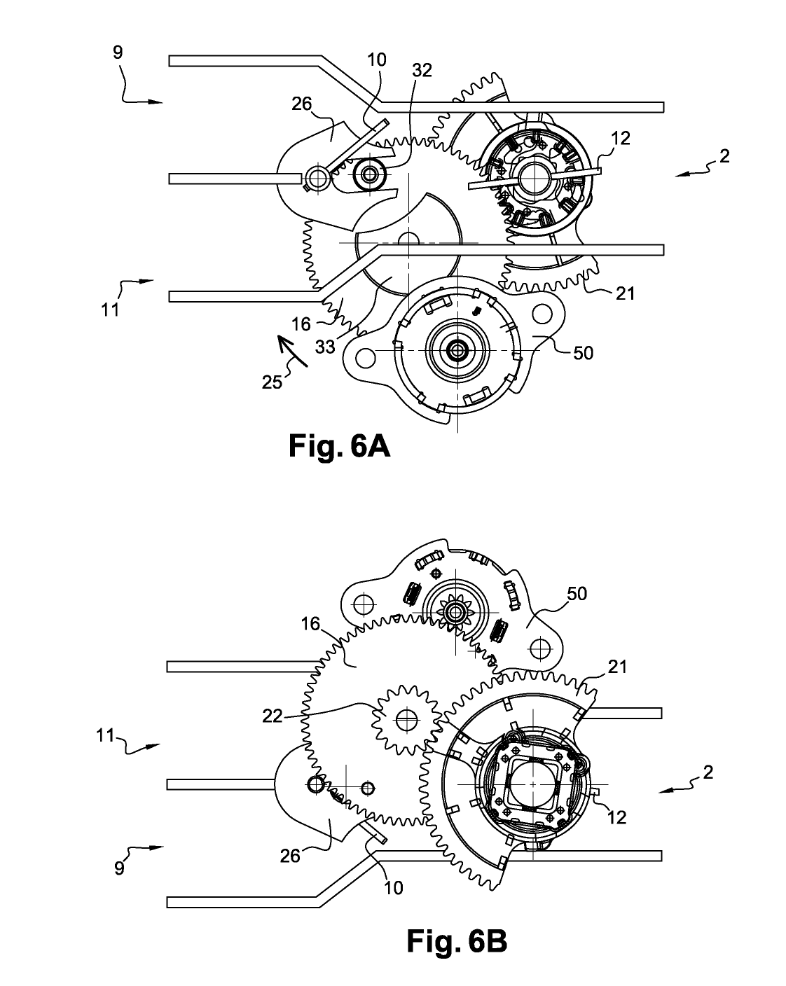

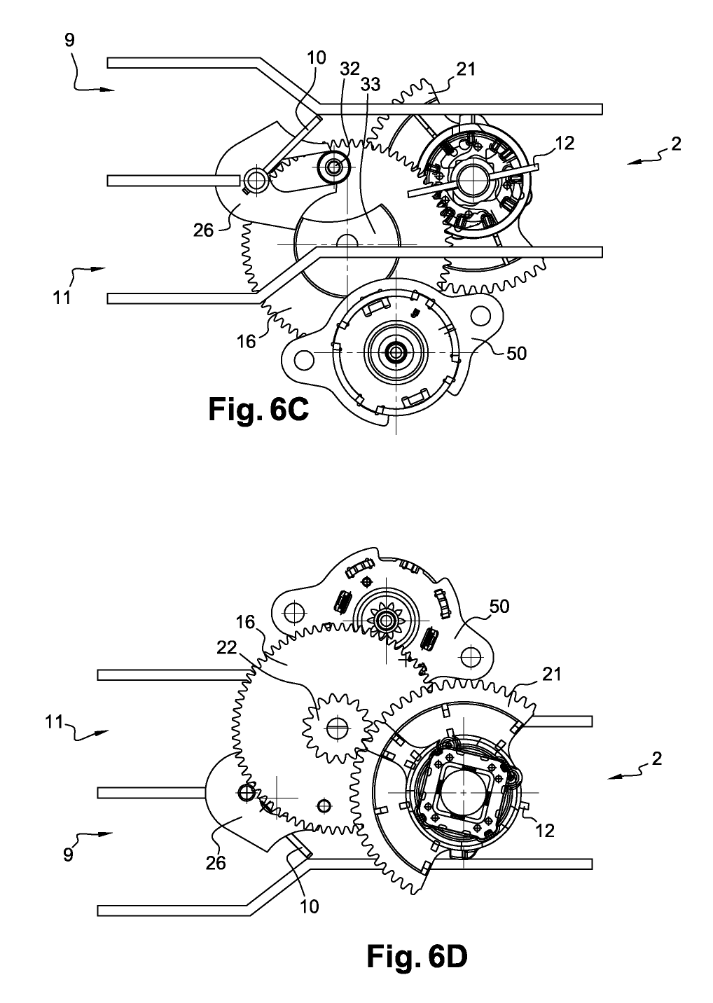

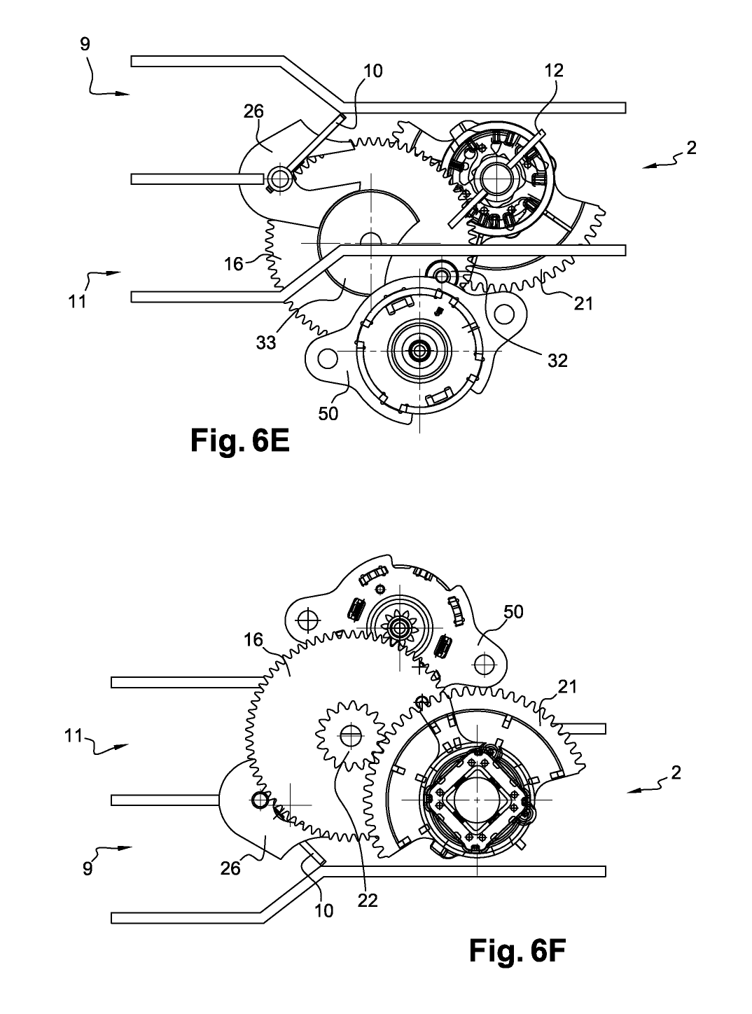

FIGS. 6A, 6C and 6E are bottom views of the actuating device of the valve according to the invention, with four different rotational stages in the direction opposite that of FIGS. 5C to 5H, of the actuating wheel, starting from the first configuration.

FIGS. 6B, 6D and 6F are top views of the actuating device of the valve according to the invention, in the states as shown in FIGS. 6A, 6C and 6E, respectively.

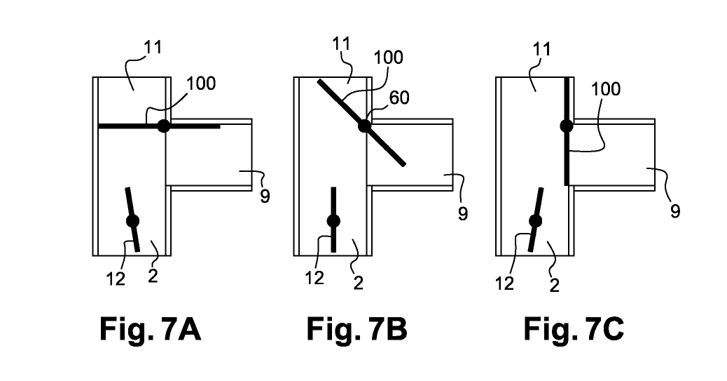

FIGS. 7A to 7C are diagrammatic views of a second embodiment of the valve according to the invention.

In reference to FIG. 1, a valve 1 is a valve placed in a portion of the air intake circuit of a turbocharged heat engine 7, which is a diesel engine in the described example, said portion comprising a channel 2 bringing supercharged air at the outlet of the compressor 6 to the intake of the engine. The engine 7 is also traditionally connected to an exhaust line 3, the exhaust gases being expanded by the passage through a turbine 4. The compressor 6 is inserted between said portion of the intake circuit and a portion of said intake circuit comprising the fresh air intake.

The portion of the air intake circuit comprising the valve 1 further comprises a supercharged air cooler 8 and a bypass channel 9 bypassing said cooler.

The valve 1 comprises a metering gate 12 able to pivot to regulate the gas flow in the channel 2 and therefore the heat engine, and a diverter gate 10 able to pivot to go from a position in which it shuts off a channel 11 for access to the cooler to a position in which it shuts off the bypass channel 9 bypassing the cooler, and vice versa.

In reference to FIG. 3, the diverter gate 10 and the metering gate 12 are controlled in their rotational movement, via the shared actuating device 15. The shared actuating device 15 of the two gates 10, 12 includes an actuating wheel 16, able to be set in rotation in both directions by the pinion 51 of the electric motor 50, the pinion 51 meshing on the actuating wheel 16. The rotation direction of said wheel 16 is dictated by the shutoff position that one wishes to assign to the diverter gate 10. This wheel 16 controls both the pivoting of the metering gate 12 and the pivoting of the diverter gate 10 using synchronized kinematics.

Thus, the actuating device 15 comprises an actuating system of the metering gate 12 and an actuating system of the diverter gate 10.

The actuating system of the metering gate 12 includes an interface part 21 that here assumes the form of a toothed sector and that is rigidly coupled to the metering gate 12. Said actuating system further includes a guide member 22 of the metering gate, which assumes the form of a pinion 22 rigidly coupled with the actuating wheel 16 and meshing on the toothed sector 21. The pinion 22 shares the same rotation axis as that of the actuating wheel 16. The rotation of the actuating wheel 16 can thus rotate the toothed sector 21, therefore the metering gate 12.

The actuating system of the diverter gate 10 is a mechanism of the “Maltese cross” type, the principle of which is based on discontinuously setting an object in the shape of a Maltese cross in rotation using a continuous rotation of a driving part interacting with said object. Thus, in the context of the invention, said actuating system includes a Maltese cross-shaped object that is an interface part 26 secured to the gate 10.

In reference to FIGS. 3, 4 and 5A, the interface part 26 comprises two parallel arms 27 arranging a slot 28 between them defining a guide path, as will be seen below, and two lateral protuberances 29, each of said protuberances 29 being placed on each side of the longitudinal axis of the slot 28.

An arm 27 and a protuberance 29 placed on the same side relative to the longitudinal axis of the slot 28 are connected to one another by an arc of circle-shaped surface 30. The interface part 26 has a base 31 aligned on the longitudinal axis of the slot 28, the axis connecting the two protuberances 29 separating said base 31 and the two arms 27. In this way, each arm 27 has an end implanted in the base 31, and another end that is free. The gate 10 has a rotation axis 14 allowing it to move between the two shutoff positions of the two channels 9, 11, the interface part 26 being rigidly fixed to one end of the gate 10 by means of said base 31. More specifically, the interface part 26 is fixed to the gate 10 such that the base 31 of the interface part 26 is crossed through by the rotation axis 14 of the gate 10. Thus, the rotation of the interface part 26 simultaneously causes the rotation of the gate 10 around its rotation axis 14 with the same angle.

Aside from the interface part 26, the actuating system of the diverter gate 10 comprises a guide part 32, here a lug attached on the actuating wheel 16 and on which a ball bearing cooperates in the described example. The lug 32 is for example cylindrical and placed on the periphery, and emerges from the plane of the actuating wheel 16 in a perpendicular direction.

The actuating system of the diverter gate 10 also comprises a maintaining part 33 that here is a fraction of another wheel coaxial with the actuating wheel 16, and secured thereto. This other wheel 33 is positioned in the central zone of the actuating wheel 16. The other wheel 33 emerges from the plane of the wheel 16 in a perpendicular direction, and thus creates an overthickness. The cross-section of the other wheel 33, which is perpendicular to its rotation axis, has a circular contour over more than half of its circumference, as well as a recess delimited by a curved segment connecting the partial circular contour to close said section.

In reference to FIG. 4, the actuating wheel 16, the maintaining part 33, the guide member 22 of the metering gate and the guide part 32 of the diverter gate form a single part forming a rigid kinematic assembly. The actuating wheel 16, the maintaining part 33 and the guide member 22 share the same rotation axis. The maintaining part 33 and the guide part 32 emerge from the plane belonging to a first face of the wheel 16, in a perpendicular direction. The guide member 22 emerges from the plane belonging to a second face of the wheel 16, opposite the first, in a perpendicular direction, thus creating an overthickness. The assembly is made in the form of a single-piece part made from molded plastic. FIG. 2 shows:
on the y-axis, the angular position of the metering gate 12 and the diverter gate 10,
on the x-axis, the angular position of the actuating wheel 16.

The curve 60 shows the angular position of the diverter gate 10 and the curve 62 shows the angular position of the metering gate 12.

The different angular positions of the metering gate and the diverter gate shown in FIGS. 5A to 7C are thus visible on the curves of FIG. 2, i.e.:
FIGS. 5A and 5B for an angular position of 0° of the actuating wheel, corresponding to the first configuration of the actuating device,
FIGS. 5C and 5D for an angular position of 25° of the actuating wheel,
FIGS. 5E and 5F for an angular position of 45° of the actuating wheel,
FIGS. 5G and 5H for an angular position of 170° of the actuating wheel,
FIGS. 6A and 6B, for an angular position of −25° of the actuating wheel,
FIGS. 6C and 6D, for an angular position of −45° of the actuating wheel,
FIGS. 6A and 6B, for an angular position of −170° of the actuating wheel.

In the first configuration of the actuating device 15, the wheel 15 has an angular position of 0°, the metering gate 12 is in the fully open position of the channel 2 (angular position equal to 0°) and the diverter gate 10 is in a position in which it does not shut off the channel 9 or the channel 11 (angular position equal to 0°).

Starting from the first configuration of the actuating device 15, a rotation in a first direction of the actuating wheel 16 to 45° causes, according to a first phase, on the one hand, an angular variation of 0° to −45° of the diverter gate 10 reflecting a pivoting in one direction to go from an open position to a shutoff position of one of the two channels 9, 11, and on the other hand, an angular variation of 0° to approximately −12° of the metering gate 12 to cause only minimal closing of said gate 12 without significantly altering the gas passage section in the supercharged air intake channel 2. In other words, the metering gate 12 remains in a quasi-open position of this angular range of the actuating wheel 16. According to a second phase, when the rotation of the actuating wheel 16 continues in the first direction to reach 350°, the diverter gate 10 remains frozen in the angular position of −45°, reflecting its maintenance in the shutoff position that it has reached, whereas the annular position of the metering gate 12 varies from −12° to −83°, reflecting a gradual closure of said gate 12 until reaching a shutoff position of the channel 2.

Still from the first configuration of the actuating device 15, a rotation in a second direction, opposite the first direction, of the actuating wheel 16 to −45° causes, according to the first phase, on the one hand, an angular variation of 0° to 45° of the diverter gate 10 reflecting pivoting in one direction to go from an opening position to a shutoff position of the other of the two channels 9, 11, and on the other hand, an angular variation of 0° to a position of approximately 12° of the metering gate 12 to cause only minimal closure of said gate 12 without significantly altering the gas flow rate in the supercharged air intake channel 2. According to the second phase, when the rotation of the actuating wheel 16 continues in the second direction to reach −350°, the diverter gate 10 remains frozen in an angular position of 45°, reflecting its maintenance in the shutoff position that it has reached, while the angular position of the metering gate 12 varies from 12° to 83°, reflecting a gradual closure of said gate 12 until reaching a shutoff position of the channel 2.

In reference to FIGS. 5A and 5B, when the actuating wheel 16 is in a reference position corresponding to the first configuration of the actuating device 15, the lug 32 of the actuating wheel 16 is positioned at the bottom of the slot 28. The two arms 27 of the interface part 26 then occupy the hollow left vacant by the maintaining part 33, their free end striking off the curved segment of said maintaining part 33.

In reference to FIGS. 5C to 5H, the actuating wheel 16 rotates gradually in the direction embodied by the arrow 23 in FIG. 5C, that rotation direction being representative of the bottom views, i.e., FIGS. 5C, 5E and 5G. FIGS. 5C and 5D, 5E and 5F, 5G and 5H show the state of the gates 10 and 12 for angular positions of the actuating wheel at the values of 25°, 45° and 170°, respectively.

In reference to FIGS. 5C and 5D, when the wheel 16 is set in rotation, in the embodied direction, for the bottom view, by the arrow 23 in FIG. 5C, from its reference position, the lug 23 causes the rotation of the interface part 26 and therefore of the diverter gate 10 secured to it, by exerting thrust on one of the two arms 27 bordering the slot 28. The gate 10 finishes by reaching a position shutting off the channel 11. The actuating wheel also causes the rotation of the interface part 21, which causes the rotation of the metering gate 12. In this first phase, the rotation of the actuating wheel 16 in the trigonometric direction from its reference position makes it possible to simultaneously pivot the diverter gate 10, so that it comes into the position shutting off the channel 11, and the metering gate 12 so that it pivots slightly while reducing the gas flow rate in the channel 2 insignificantly.

In reference to FIGS. 5E and 5F, once the diverter gate 10 has reached its position shutting off the channel 11, the metering gate 12 reaches angular position of approximately −12°. In this position of the metering gate 12, the flow rate of the gases flowing in the channel 2 is practically unchanged relative to the flow rate that was flowing when the actuating device was in the first configuration. In fact, the maximum flow rate in the channel 2 is that which passes through the total section of said channel, minus the section of the axis of the metering gate 12. The flow rate in the channel 2 is unchanged as long as the projection, in a plane normal to the flow of gas in the channel of the metering gate, is equal to the section of that plane of the axis.

The actuating wheel 16 can next continue, during the second phase, its rotation in the same direction, so as to gradually pivot the metering gate 12 to gradually close the channel 2 and thus regulate the passage of the gases in that channel, while keeping the diverter gate 10 in its shutoff position, owing to the maintaining part 33 of the actuating wheel 16, against which the arc of circle-shaped segment 30 of the interface part 26 bears.

In reference to FIGS. 5G and 5H, the actuating wheel 16 can continue its rotation according to the second phase and still in the same direction, so as to continue the maintenance of the diverter gate 10 in its position shutting off the channel 11 and while continuing the pivoting of the metering gate 12 to shut off the channel 2. Thus, the flow rate of the gases in the channel 2 is decreased by pivoting of said metering gate 12 controlled by the actuating wheel 16, while the diverter gate 10 remains in a position shutting off the channel 11. At any time, the actuating wheel 16 can be set in rotation in the opposite direction to adjust the position of the metering gate 12, therefore to increase the flow rate of the gases in the channel 2.

In reference to FIGS. 6A to 6F, the actuating wheel 16 can also be set in rotation in the opposite direction from its reference position, i.e., in the direction embodied by the arrow 25 in FIG. 6A, that rotation direction being representative of the bottom views, i.e., FIGS. 6A, 6C and 6E, so as to allow the diverter gate 10 to shut off the channel 9 and to allow the metering gate to shut off the channel 2.

In reference to FIGS. 6A and 6B, the rotation of the actuating wheel 16 in the opposite direction, starting from the first configuration of the actuating device 15, makes it possible, according to the first phase, to simultaneously pivot the diverter gate 10, so that it comes into a position shutting off the channel 9, and the metering gate 12 so that it pivots slightly while reducing the flow rate of the gases in the channel 2 insignificantly. In that case, the diverter gate 10 pivots in a direction opposite that in which it pivots in the example described in reference to FIGS. 5A to 5H, to shut off the channel 11, while the metering gate 12 still pivots in the same direction as that in which it pivots in the example described in reference to FIGS. 5A to 5H, to gradually close the channel 2.

In reference to FIGS. 6C and 6D, once the diverter gate 10 has reached a position shutting off the channel 9, the actuating wheel 16 continues, according to the second phase, its rotation in the same direction, in order to continue to pivot the metering gate 12, resulting in gradually closing the channel 2, while keeping the diverter gate 10 in its position shutting off the channel 9, owing to the maintaining part 33 of the actuating wheel 16, against which the arc of circle-shaped segment 30 of the interface part 26 bears.

In reference to FIGS. 6E and 6F, the rotation of the actuating wheel 16 can continue, still in the same direction, until the metering gate 12 has reached a position shutting off the channel 2. Thus, the adjustment of the opening degree of the metering gate 12 is done by pivoting of said metering gate 12, controlled by the actuating wheel 16, while the diverter gate 10 remains in a position shutting off the channel 9. At any time, the actuating wheel 16 can be set in rotation in the opposite direction to adjust the opening position of the metering gate 12, then increasing the flow rate of the gases in the channel 2.

In the example illustrated in FIGS. 7A, 7B and 7C, the rotation axis 60 of the diverter gate 100 is placed at the center of said gate 100, such that part of the gate 100 situated on one side of said axis 60 is brought to shut off an outlet channel 9, 11, while the other part situated on the other side of said axis 60 is brought to shut off the other outlet channel 9, 11. The general mechanism for movement of the gates 100, 12 remains globally unchanged relative to that previously described. In this example, the diverter gate 100 is less sensitive to the torque related to the pressure of the fluid flowing in the valve and tending to cause it to pivot.

1. A valve an engine control valve, comprising:
at least three channels opening into a common inner space;
a metering gate pivotable in a first channel to vary the passage section of the fluid in the latter;
a diverter gate pivotable between a position for shutting off a second channel and a position for shutting off a third channel; and
a shared actuating device of the gates,
the actuating device including at least one actuating wheel rotatable to pivot at least one of the diverter gate and the metering gate,
the actuating device having at least one first configuration in which the metering gate is in a position in which it does not shut off the first channel and in which the diverter gate is in an intermediate position in which it is not in the position shutting off the second channel or in the position shutting off the third channel, and
the actuating device being configured so that the rotation of the actuating wheel while the actuating device is in the first configuration leads to:
according to a first phase, substantial pivoting of the diverter gate while the metering gate is only subject to slight pivoting, and
according to a second phase after the first phase, pivoting of the metering gate to alter the passage section of the fluid in the first channel without the position of the diverter gate being modified.

2. The valve according to claim 1, the actuating device being configured so that in the first configuration, the metering gate is in the completely open position of the first channel.

3. The valve according to claim 1, the actuating device being configured so that the rotation of the actuating wheel while the actuating device is in the first configuration leads to:
in a first rotation direction, the pivoting of the diverter gate to the shutoff position of the second channel, and
in a second rotation direction, the pivoting of the diverter gate to the shutoff position of the third channel.

4. The valve according to claim 1, the actuating device being able to keep the diverter gate in one or the other of the shutoff positions of the second or third channel, while the actuating wheel continues a unidirectional rotational movement from the first configuration.

5. The valve according to claim 1, the actuating device comprising an actuating system of the diverter gate, said actuating system comprising a guide part and an interface part, the actuating wheel being rigidly coupled to the guide part and the diverter gate being rigidly coupled to the interface part, the guide part cooperating with the interface part to pivot the diverter gate.

6. The valve according to claim 1, the actuating device comprising a system for actuating the metering gate, said actuating system comprising a guide member and an interface part, the actuating wheel being connected to the guide member so as to pivot the latter during its rotation, and the interface part being rigidly coupled to the metering gate, and the guide member cooperating with said interface part to pivot the metering gate.

7. The valve according to claim 5, the guide member of the actuating system of the metering gate and the guide part of the actuating system of the diverter gate being separate and rigidly connected to one another.

8. The valve according to claim 5, the actuating wheel cooperating with the guide part of the actuating system of the diverter gate via a first zone of said wheel and the actuating wheel cooperating with the guide member of the actuating system of the metering gate via a second zone of said wheel, different from the first zone.

9. The valve according to claim 6, the guide member of the actuating system of the metering gate comprising a pinion cooperating with the interface part of the actuating system of the metering gate.

10. The valve according to claim 5, the interface part of the actuating system of the diverter gate being configured to define a guide path of the guide part with which it cooperates.

11. The valve according to claim 10, the guide path being formed by a blind slot arranged in said interface part, said guide part resting in the blind slot when the diverter gate is in the intermediate position.

12. The valve according to claim 11, said guide part exerting, when it rests in the slot and under the effect of a rotation of the actuating wheel, thrust on said interface part to pivot the diverter gate.

13. The valve according to claim 10, the actuating system of the diverter gate comprising a maintaining part for the interface part of said actuating system, said maintaining part being rigidly coupled with the actuating wheel.

14. The valve according to claim 13, said maintaining part and said interface part comprising complementary surfaces, such that the cooperation between these complementary surfaces keeps said interface part in position during the movement of said guide part, while the diverter gate is in one or the other of the shutoff positions.

15. The valve according to claim 1, the metering gate having no sealing segment.

16. The valve according to claim 1, the first configuration being an idle position of the metering gate and the diverter gate.

17. The valve according to claim 1, the metering gate having a rotation axis and said gate extending in a plane including said rotation axis.

18. The engine control valve according to claim 1, being placed in a portion of an air intake circuit of a diesel engine of a vehicle, said portion being downstream from a compressor and said portion comprising a supercharged air cooler and a bypass channel bypassing said cooler, the metering gate regulating the gas flow in said engine and the diverter gate shutting off either an access channel to said cooler, or the bypass channel bypassing the cooler.
